(19) United States
(12) Patent Application Publication
(10) Pub. No.: US 2008/0090045 A1
(43) Pub. Date: Apr. 17, 2008

(54) Thin Film Made Of Extensible Plastic Material for Packaging , Renforced And At Least Partially Stretched, Having High Mechanical Strength

(75) Inventor: Antonio Garegnani, Vermezzo (MI) (IT)

Correspondence Address: YOUNG & THOMPSON, 745 SOUTH 23RD STREET, 2ND FLOOR, ARLINGTON, VA, 22202, US

(73) Assignee: AKRO- FLEX S.A.S DI GAREGNANI ANTONIO & C., VERMEZZO (MI) (IT)

(21) Appl. No.: 11/658,323

(22) PCT Filed: Aug. 10, 2005
(86) PCT No.: PCT/IT05/00489

§ 371 Date: Jan. 24, 2007

(30) Foreign Application Priority Data
Aug. 12, 2004 (IT) RM2004A000412

(51) Int. Cl. B32B 3/14; B29C 55/06; B29C 65/00

(52) U.S. Cl. 428/47; 264/173.1

(57) ABSTRACT

A film (1) made of extensible packaging material, characterized in that it is provided with longitudinal, reinforcing, side strips (f) which partially overlap the edges (B) of the film to increase its width, the thus reinforced film being subjected at least to a partial stretching.

The present invention relates to packaging films.

A lot of packaging films made of extensible plastic material are known today. They can be extensible completely and stretched partially or until a zero residual stretch.

It is also known that the tensile strength increases as the stretching applied to the film rises, under the same thickness of the film.

In this product line the term “stretched film” usually indicates an extensible film which has been subjected to a more or less strong stretching but still has a residual stretch so that it can be further stretched. The expression “zero residual stretch film” is usually used to indicate a film that has been completely stretched so that it cannot undergo further stretching.

A first problem of the presently known stretched films is that they can easily be torn usually from the side edges to the centre of the film upon packaging of goods.

A second problem of the presently marketed stretched films is that the unavoidable reduction in the width of the stretched film with respect to its original width because of the stretching produces film bobbins having a lower width than the standard bobbins for packaging film (for example 50 cm). To this end, it should be appreciated that many packaging machines do not allow films with a lower width than the standard one to be used or in any case they should be suitably modified to accept one and only one specific width.

The main object of the present invention is to overcome the above-mentioned problems by providing an extensible packaging film reinforced by longitudinal side strips made of the same material as the film which is subjected at least to a partial stretching, which longitudinal strips projects laterally from the edges of the film, thus increasing its width reduced by stretching.

This object has been accomplished according to the invention by coupling an extensible packaging film to two reinforcing longitudinal strips of the same material disposed along the side edges of the film so as to overlap such edges only partially, and by applying the same longitudinal stretching to the film and the reinforcing longitudinal strips before winding the film about the reels.

A better understanding of the invention will result from the following detailed description with reference to the accompanying drawings that show a preferred embodiments thereof only by way of a not limiting example.

In the drawings:

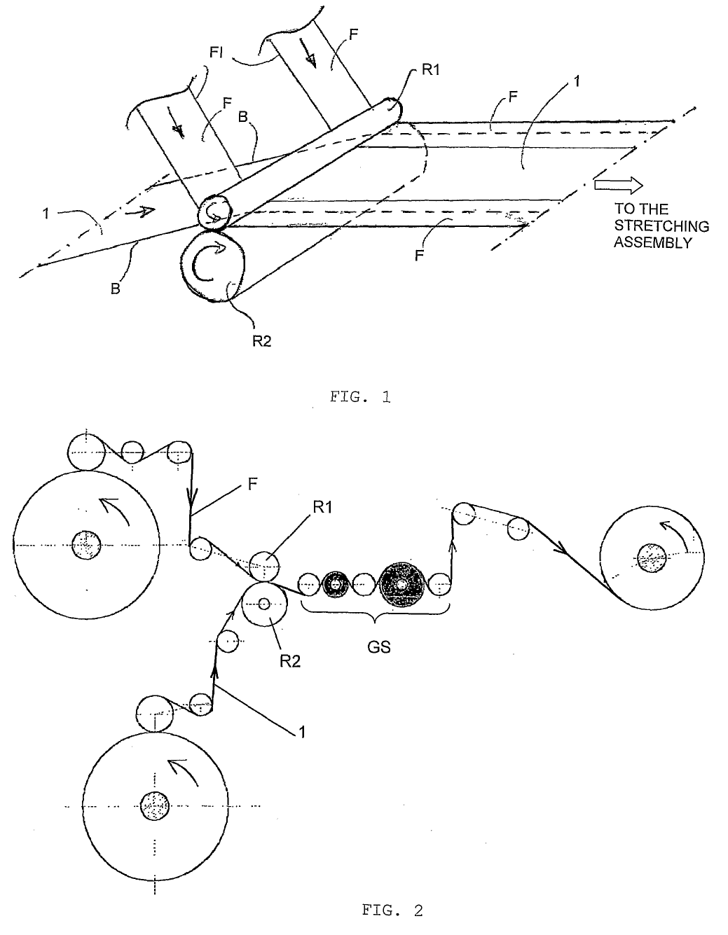

FIG. 1 is a diagram showing the coupling of the film to the longitudinal reinforcing strips; and

FIG. 2 is an exemplary diagram of the arrangement of the coupling rollers and the stretching assembly of a film manufacturing machine.

With reference to the figures mentioned above the extensible packaging film disclosed is stretched at least partially and is provided with longitudinal reinforcing strips made of the same material which overlap partially the side edges of the film to bring the total width of the film to the size of 50 cm or any other desired width.

According to the invention, the central extensible film 1 is first coupled to the longitudinal reinforcing strips F and then stretched together with the strips before being re-wound about a storage reel. In the embodiment illustrated schematically in the figures the coupling is carried out by a pair of coupling or pressure rollers R1 and R2, and the stretching is accomplished by a “stretching assembly” GS of the known type.

From the foregoing it is self-evident that the transversal dimension of the reinforced film, i.e. its final width, depends on the stretching intensity to which the film is subjected as well as the starting width, the width of the longitudinal side strips and the overlapping amount of such strips F on film 1. For example, a stretched, reinforced film having the same final width, an equal or lower weight per unit surface, and a much higher mechanical strength can be advantageously obtained from a not stretched film having a standard width of 50 cm.

It should be noted that the increase in the mechanical characteristics allows the thickness of film 1 and side strips F to be strongly reduced and the same mechanical strength to be provided.

Moreover, according to a variation of the present invention (not shown), the mechanical strength of the stretched, reinforced film can be further increased by “edging again” in a known manner the side edges of central film 1 and/or the inner edges of side reinforcing longitudinal strips F before coupling them to one another. In short, further rollers of the known type for edging again edges B of central film 1 and/or inner edges FI of reinforcing strips F, as desired, are arranged upstream of coupling or pressure rollers R1 and R2 to carry out such edging.

To this end, it should be appreciated that according to the invention it is suitable to edge again the outer edges of longitudinal strips F as such edging would provide a storage reel that would not unroll as the elastic memory of the materials which such extensible packaging films are made of would cause the film to tear continuously.

A further variation of the invention (not shown) couples the film so far disclosed to a central longitudinal reinforcing strip or more longitudinal strips spaced apart from one another and the side strips uniformly.

A first advantage of the invention so far disclosed is that a stretched, reinforced film having exactly the same desired width can be obtained by adjusting in a suitable way the width of reinforcing side strips F and the overlapping amount on central film 1.

A second advantage is that the film according to the invention has a weight for unit surface which is essentially the same as the stretched, not reinforced film of the presently marketed type.

A third advantage of the invention is that the film so far disclosed has a mechanical strength as well as a tearing propagation strength which are much greater than the stretched and not stretched films of the prior art: in fact, the longitudinal overlap areas form a real “barrier” to tearing propagation.

The present invention has been described and illustrated according to a preferred embodiment thereof, however, it is self-evident that those skilled in the art can make technically equivalent modifications and/or replacements without departing from the scope of the present industrial invention.

1. A film made of extensible packaging material, characterized in that it is provided with longitudinal, reinforcing, side strips (F) which partially overlap the edges of film (1) to increase its width, the thus reinforced film being subjected at least to a partial stretching.

2. The film according to claim 1, characterized in that it is coupled to said longitudinal reinforcing strips (F) by a pair of coupling or pressure rollers (R1 and R2), and the next stretching of film (1) and side strips (F) is accomplished by a “stretching assembly” (GS) of the known type so that the transversal dimension of the reinforced film, i.e. its final width, depends on the stretching intensity to which the film is subjected as well as the starting width, the width of the longitudinal side strips and the overlapping amount of such strips (F) on film (1).

3. The film according to claim 2, characterized in that it has the same final width as starting film (1) to which side strips (F) have been coupled, an equal or lower weight per unit surface, and a much higher mechanical strength, the increase in the mechanical characteristics because of stretching allowing the thickness of film (1) and side strips (F) to be strongly reduced and the same mechanical strength to be achieved.

4. The film according to claim 1, characterized in that its side edges (B) and/or inner edges (FI) of longitudinal reinforcing strips (F) coupled thereto are edged again, thus providing that in each overlap area between film (1) and reinforcing strips (F) is obtained at least a longitudinal border or bead that further increases mechanical and tearing strengths.

5. The film according to claim 1, characterized in that it has a mechanical strength as well as a tearing propagation strength which are much greater than the stretched and not stretched films of the prior art as the longitudinal overlap areas form a real “barrier” to tearing propagation.

6. The film according to claim 1, characterized in that it includes a further central longitudinal reinforcing strip or more longitudinal strips spaced apart from one another and said side reinforcing strips (F) uniformly.

7. A method of manufacturing a film according to claim 1, characterized by the following steps:
coupling an extensible packaging film (1) to two longitudinal reinforcing strips (F) of the same material which are arranged along the side edges of film (1) so as to overlap only partially the same, and
applying the same longitudinal stretching to film (1) and longitudinal reinforcing strips (F) before winding the film about the reels.

8. (canceled)
